(19) United States
(12) Patent Application Publication
(10) Pub. No.: US 2006/0182861 A1
(43) Pub. Date: Aug. 17, 2006

(54) Device for partially sectioning baked products and method of using the same

(76) Inventor: Karsten Achim Richard Arend, Toronto (CA)

Correspondence Address: SAND & SEBOLT, AEGIS TOWER, SUITE 1100, 4940 MUNSON STREET, NW, CANTON, OH, 44718-3615, US

(21) Appl. No.: 11/058,788

(22) Filed: Feb. 16, 2005

(51) Int. Cl. A23P 1/00

(52) U.S. Cl. 426/518

(57) ABSTRACT

A device for sectioning baked products, such as bagels or donuts, so that those baked products are partitioned into bite size pieces which remain partially attached to each other so that the baked product substantially maintains its original pre-sectioned shape. The device includes a housing with a wall and a plunger-activated blade that travels within the housing interiorly of said wall. The blade slides through a slotted plate disposed inwardly of a lower edge of the housing. When the plunger is pushed toward the housing, the blade slides through the slotted plate and cuts into the baked product. The sectioning device includes a limiting mechanism which prevents the cutting edge of the blade from cutting entirely through the baked product. When the plunger is released, the slotted plate causes the sectioned baked product to release from the blade as it is withdrawn through the slot. A plurality of blades and corresponding slots in the slotted plate, may be provided to section the baked product into a plurality of segments.

### BACKGROUND OF THE INVENTION

1. Technical Field

This invention generally relates to baked products. More particularly, the invention relates to a device and method for partially sectioning baked products. Specifically, the invention relates to a device for sectioning a baked product which does not cut entirely through the baked product and thereby allows the product to substantially maintain its original shape.

2. Background Information

It is common for people to purchase baked products such as donuts and bagels and then eat those products in a location remote from the establishment from which they purchased the product. Donuts and bagels are typically sold as a one piece product and are placed in a paper bag for the consumer to carry. These products are frequently eaten on the run, in a car, with the consumer attempting to tear off bite size pieces of the product to eat. In order to do this, the consumer must reach inside the bag and either remove the entire donut or bagel, and bite into the product or tear off a piece of the same from the whole baked product. Alternatively, they may keep the whole product inside the bag and simply tear off pieces when they are ready to eat the same. Reaching into the bag several times to tear of pieces of donuts in particular, tends to be difficult and the consumer ends up with filling or frosting all over their hand. Furthermore, the actual act of tearing off a piece of the product may be fairly difficult, especially if the consumer is attempting to eat the product in a car and is essentially using only one hand to break a piece off the whole product.

There is therefore a need in the art for a device which will make it easier to remove bite size pieces from baked products such as donuts or bagels.

### SUMMARY OF THE INVENTION

The present invention is a device and method for partially sectioning baked products, such as bagels or donuts, so that those baked products are partitioned into bite size pieces which remain partially attached to each other so that the baked product substantially maintains its original pre-sectioned shape.

The device includes a housing having a wall which defines an interior cavity and a plunger-activated blade that travels interiorly of the wall and within the cavity. The blade slides through a slotted plate disposed inwardly of a lower edge of the housing. When the plunger is pushed toward the housing, the blade slides through the slotted plate and cuts into the baked product. The sectioning device includes a limiting mechanism which prevents the cutting edge of the blade from reaching the lower edge of the housing. Consequently, the blade only cuts partially through the baked product. When the plunger is released, the slotted plate causes the sectioned baked product to release from the blade as it is withdrawn through the slot. A plurality of blades, and corresponding slots in the slotted plate, may be provided to section the baked product into a plurality of segments.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of a first embodiment of sectioning device in accordance with the present invention, with the housing of the device shown in phantom;

FIG. 1a is an enlarged perspective view of the upper portion of the housing and the handle;

FIG. 2 is an exploded perspective view of the device of FIG. 1;

FIG. 3 is a side view of the device of FIG. 1;

FIG. 4 is a cross-sectional side view of the device showing the blades partially cutting through a baked product;

FIG. 4a is an enlarged view of a part of FIG. 4 showing a screw mechanism for adjusting the position of contact between the plunger and the housing to change the degree of travel of the blade within the housing;

FIG. 5 is a perspective view of a baked product which has been cut by the sectioning device of the present invention illustrating that the baked product is partitioned, but not separated;

FIG. 6 is a perspective view of a second embodiment of the sectioning device in accordance with the present invention and showing the housing of the device in phantom;

FIG. 7 is an exploded perspective view of the device of FIG. 6;

FIG. 8 is a side view of the device of FIG. 6;

FIG. 9 is a cross-sectional top view through line 9-9 of FIG. 8;

FIG. 10 is a perspective view of a baked product which has been cut by the sectioning device of FIG. 6, illustrating that the baked product is partitioned, but not separated; and

FIG. 11 is a perspective view of a third embodiment of a sectioning device in accordance with the present invention and showing the housing of the device in phantom.

### DETAILED DESCRIPTION OF THE INVENTION

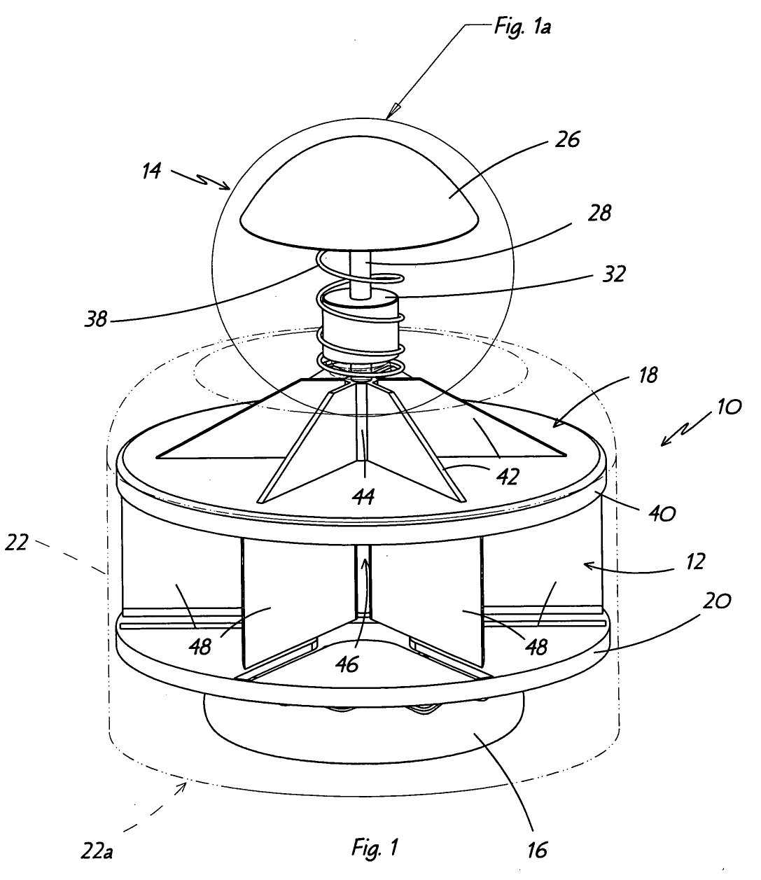

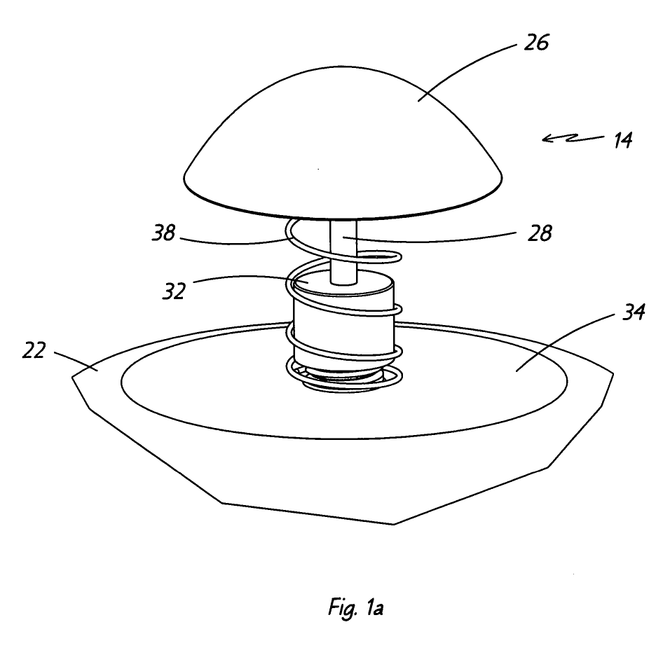

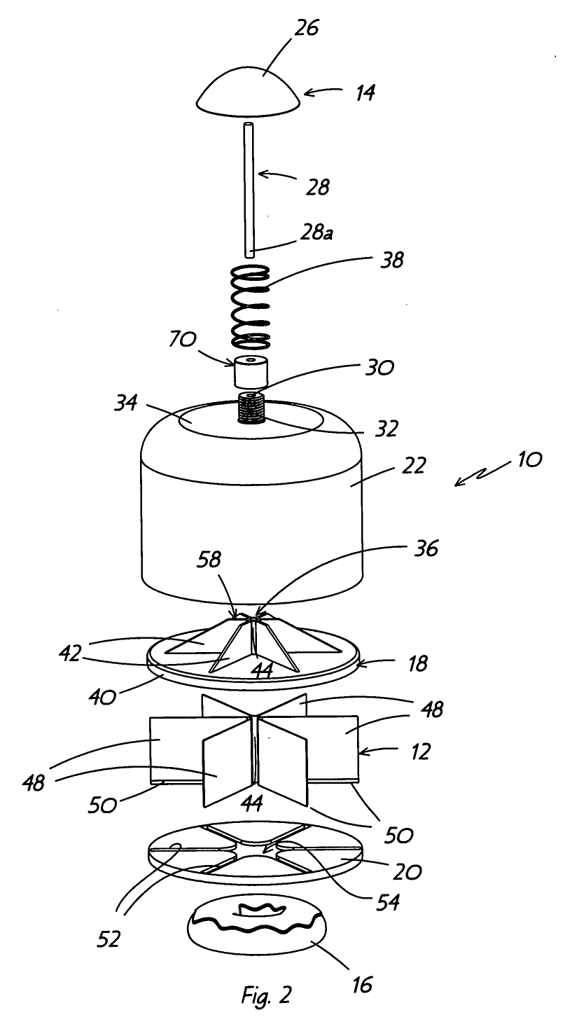

Referring to FIGS. 1-5 there is shown a first embodiment of a hand-held sectioning device in accordance with the present invention and generally indicated at 10. Sectioning device 10 includes blades 12 which are manipulated via a spring-loaded plunger 14 to partially cut into a baked product 16 such as a donut or bagel. The partially cut baked product 16 substantially maintains its original shape but is easier to separate into bite sizes pieces.

Sectioning device 10 comprises the plunger 14 and blades 12, which are connected in a suitable manner to a first plate 18, and further includes a slotted second plate 20 which is received within a housing 22.

Plunger 14 comprises a handle 26 and a shaft 28. Shaft 28 is inserted through an aperture 30 in a boss 32 which extends from the top wall 34 of housing 22. The lower end 28a of shaft 28 is inserted through a bore 36 in first plate 18 and is fixedly connected to first plate 18 by any suitable means such as by an adhesive. A spring 38 is disposed around shaft 28 and boss 32 and lays between the underside 26a of handle 26 and top wall 34 of housing 22.

First plate 18 is disposed beneath the top wall 34 of housing 22 and comprises a circular disc 40 with a plurality of strengthening flanges 42 disposed around a central core 44. Bore 36 extends through core 44. First plate 18 moves with shaft 28 of plunger 14 because the lower end 28a of shaft 28 is secured to first plate 18. First plate 18 is provided to secure blades 12 to plunger 14 and to limit the upward travel of blades 12 within housing 22.

Blades 12 are secured to and extend outwardly away from the lower surface 18a of first plate 18. Blades 12 include a central core 46 from which a plurality of partitioning blades 48 radiate. Partitioning blades 48 include a cutting edge 50. Blades 12 move up and down with first plate 18 inside housing in response to movements of plunger 14.

Second plate 20 comprises a circular disc having a plurality of slots 52 radiating outwardly from a central aperture 54. Slots 52 are complementary sized and spaced to receive the partitioning blades 48 of blades 12 therethrough. Second plate 20 preferably is frictionally secured within the interior of housing 22. As the partitioning blades 48 of blades 12 are moved with first plate 18 in response to movements in plunger 14, partitioning blades 48 move into and out of slots 52 of second plate 20. Second plate 20 is provided to protect the cutting edges 50 of blades 12 from damage and to prevent users from accidentally cutting themselves on cutting edges 50 of blades 12. Second plate 20 is also provided to limit the upward travel of the baked product 16 as blades 12 is withdrawn therefrom.

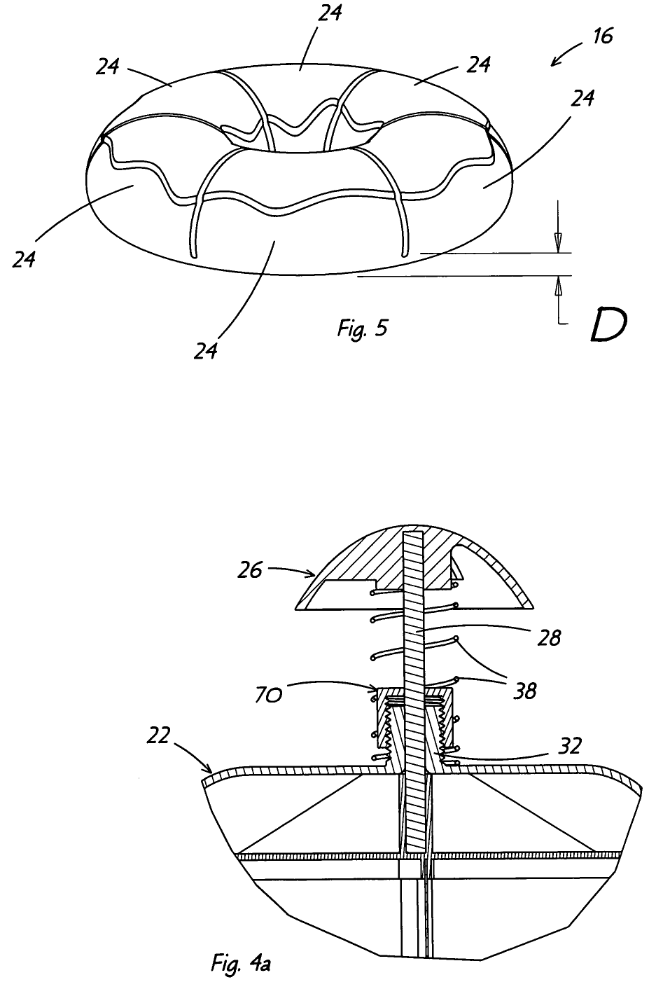

Housing 22 is generally cylindrical in shape having a wall that forms an interior cavity 23 (FIG. 4) for receiving blades 12 and first and second plates 18, 20 therein. Housing 22 preferably is manufactured from a transparent material so that baked product 16 can be viewed therethrough. Housing 22 includes a lower edge 22a which lies a distance from the interior 34a of top wall 34. First and second plates 18, 20 and blades 12 move within the interior cavity 23 of housing 22. Cutting edges 50 of blades 12 do not extend below lower edge 22a of housing 22 and are spaced inwardly a distance “C” from lower edge 22a of housing 22 when first plate 18 is in the second or down position. Housing 22 thereby substantially prevents easy access to blades 12 when sectioning device is not in use, as blades 12 lie above the second plate 20 when device 10 is not in use. This reduces the risk of the user cutting themselves on the sides of partitioning blades 48 or from damaging the blades accidentally. It may be seen from FIG. 4a that boss 32 on housing 22 may include a mechanism for adjusting the point at which the underside 26a of handle 26 engages boss 32 to adjust the position at which the downward travel of the plunger 14 is halted. The mechanism may take the form of a screw 70 which can be screwed upwardly or downwardly to raise or lower the contact point at which the underside 26a of handle 26 engages the boss 32 and thereby halts downward travel of plunger 14. Any other suitable mechanism may be provided to accomplish this end.

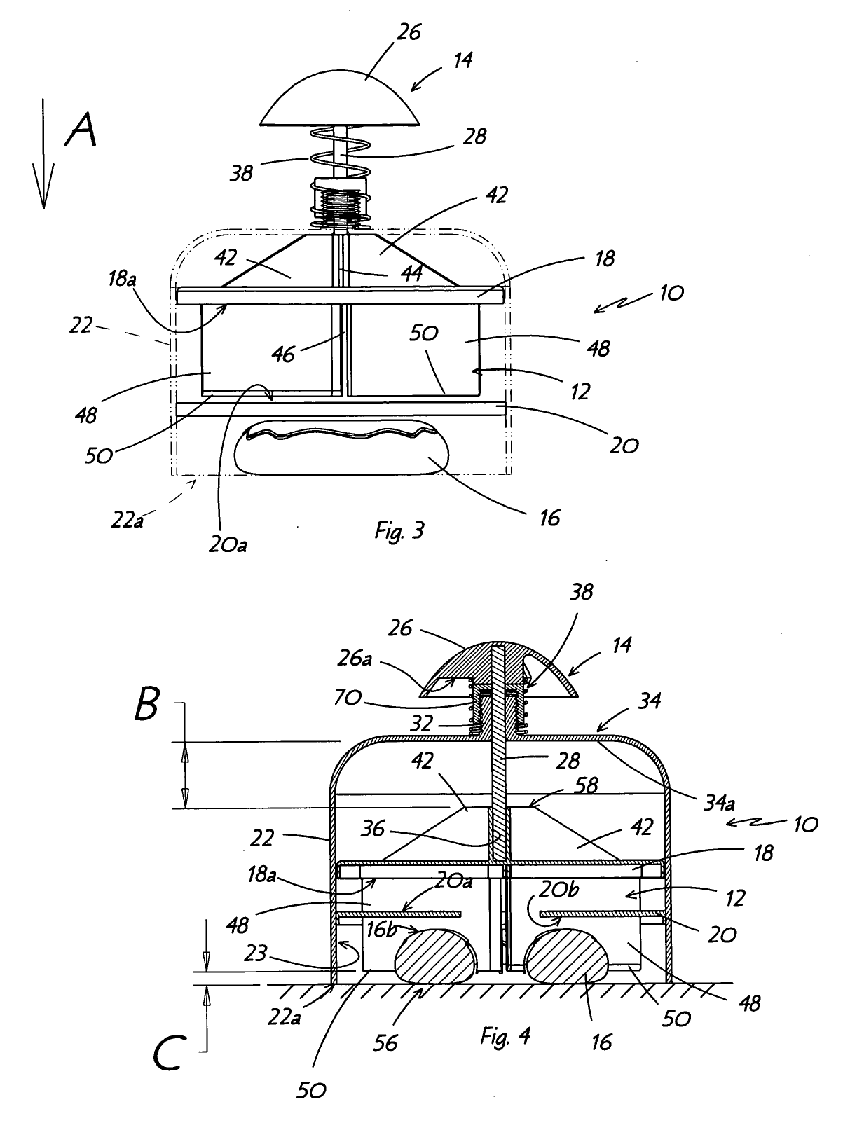

Sectioning device 10 is used in the following manner. A baked product 16 is placed on a flat surface 56 such as a kitchen counter. Housing 22 is positioned over baked product 16 so that lower edge 22a of housing 22 rests on surface 56 and baked product 16 lies within the perimeter created by lower edge 22a. The user then pushes handle 26 of plunger 14 downwardly in the direction of arrow “A” (FIG. 3). This downward movement compresses spring 38 against top wall 34 of housing 22. At the same time, the downward movement causes first plate 18 and blades 12 to move downwardly within housing 22, as can be seen in FIG. 4 where upper edges 58 of flanges 42 have moved a distance “B” downwardly from interior surface 34a of top wall 34. The downward movement causes partitioning blades 48 of blades 12 to move through slots 52 in second plate 20 and into the body of baked product 16. When the underside 26a (FIG. 4) of handle 26 engages boss 32, the downward movement of plunger 14 is arrested. At this point, cutting edges 50 of partitioning blades 48 have not cut entirely through to the underside 16a of baked product 16. As can be seen in FIG. 5, a layer of baked product 16 having a depth “D” remains uncut. Depth “D” is equal in size to distance “C” (FIG. 4) which is the distance between the bottom of cutting edge 50 and lower edge 22a of housing 22. Preferably, approximately 10%-95% and preferably about 80% of the depth of baked product 16 is cut through by blades 12. This means that segments 24 of baked product 16 remain attached to each other and baked product 16 substantially maintains its original shape. Baked product 16 is therefore divided into segments 24, but segments 24 are not completely separated from each other. The user then releases handle 26 and spring 38 urges plunger 14 upwardly in a direction opposite to arrow “A” (FIG. 3). This in turn causes upward movement of first plate 18 and blades 12. Baked product 16 may be drawn upwardly by blades 12 as plunger 14 returns to its original position, but when upper surface 16b of baked product 16 contacts lower surface 20b of second plate 20, the product's upward movement is arrested and it drops back onto surface 56. Partitioning blades 48 are withdrawn upwardly through slots 52 so that cutting edges 50 once again lie above upper surface 20a of second plate 20. It will be seen from FIGS. 3 & 4 that the cutting edges 50 of blades 12 always lie inwardly of lower edge 22a of housing 22. When the consumer desires to break a segment 24 from baked product 16, they simply pull on the desired segment 24 and, because there is less baked material to tear, the desired segment easily separates from baked product 16. It is contemplated that sectioning device 10 would be used by an employee of a bakery or fast food restaurant. It is also contemplated that this type of device could be mechanized to rapidly partition a plurality of baked products.

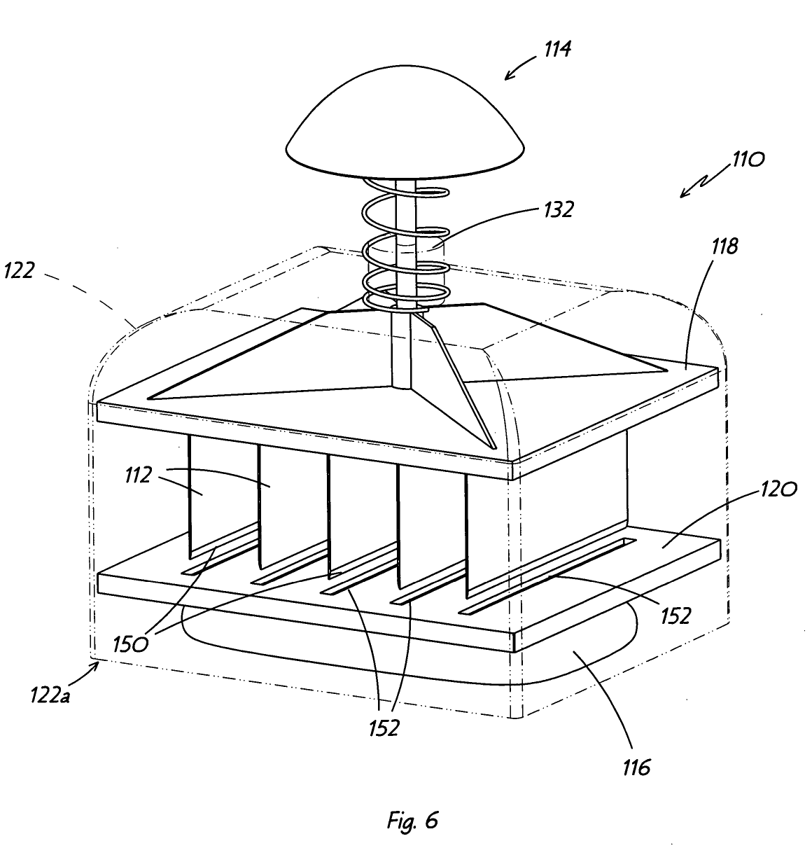

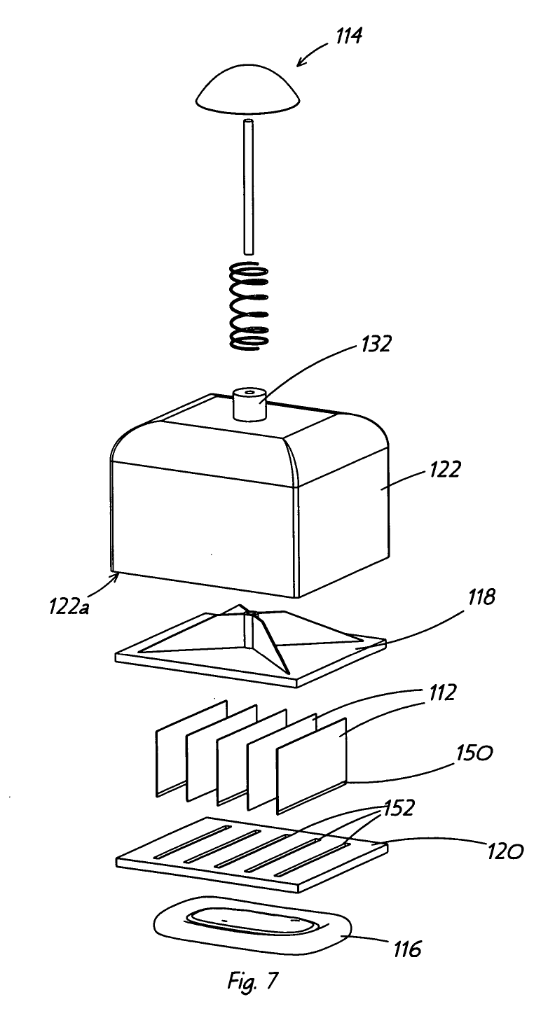

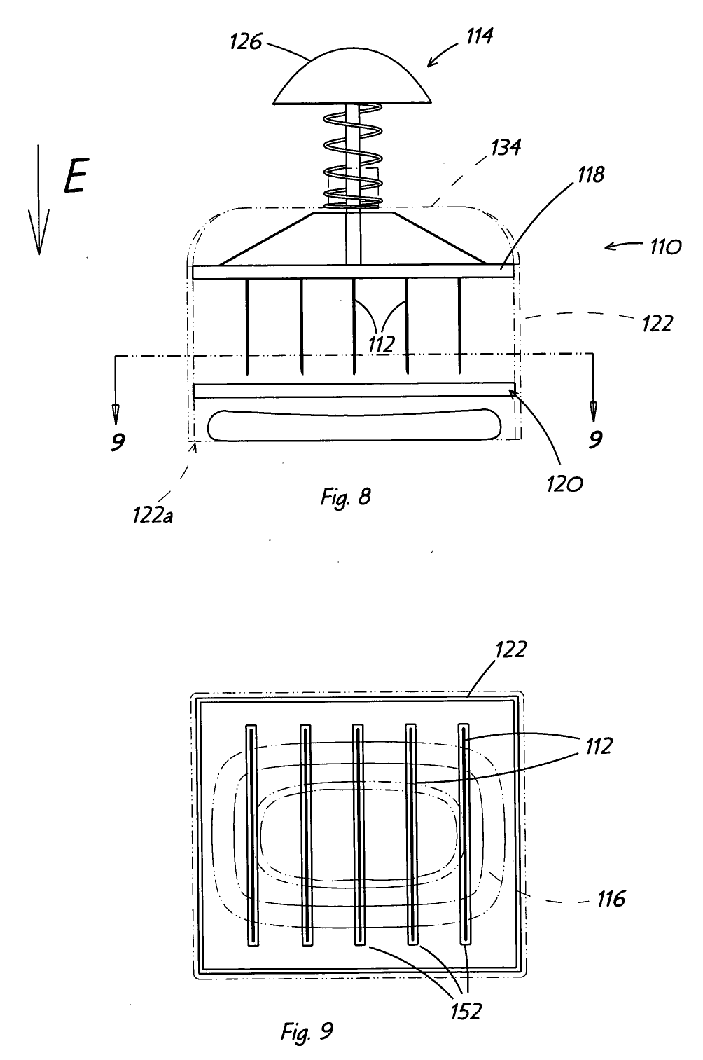

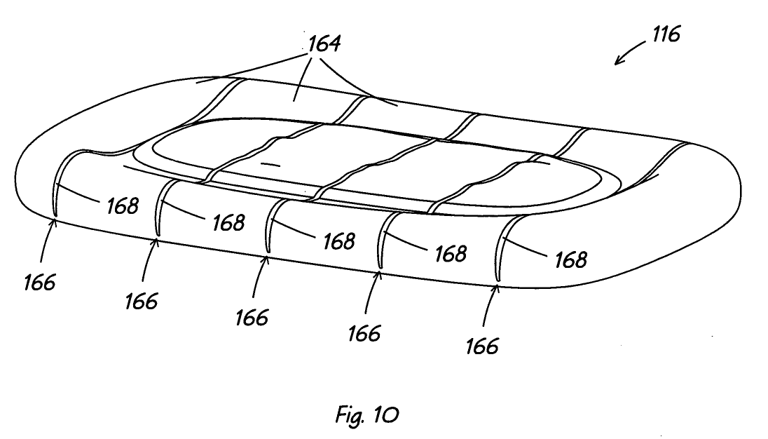

Referring to FIGS. 6-9, there is shown a second embodiment of a sectioning device in accordance with the present invention and generally indicated at 110. Sectioning device 110 is adapted to partition a substantially rectangular baked product 116. As with the first embodiment, sectioning device 110 includes a housing 122, a spring-biased plunger 114, a reinforced first plate 118 with a plurality of blades 112 extending outwardly therefrom and a slotted second plate 120 through which blades 112 can travel. Housing 122 and first and second plates 118, 120 are substantially rectangular in shape. Blades 112 are arranged spaced apart and parallel to each other along the length of the underside of first plate 118. Slots 152 in second plate 120 are spaced and sized to be complementary to blades 112. When plunger 114 moves first plate 118 and therefore blades 112 downwardly in the direction of arrow “E” (FIG. 8), the cutting edges 150 of blades 112 cut into the body of baked product 116. The downward travel of blades 112 is arrested when the underside (not shown) of handle 126 engages boss 132 extending outwardly from top wall 134 of housing 122. Blades 112 are prevented from cutting completely through baked product 116 because cutting edges 150 of blades 112 reach their lowermost point inside housing 122 when they lie a spaced distance inwardly from lower edge 122a of housing 122. Baked product 116 is partitioned into a plurality of rectangular segments 164 (FIG. 10). Segments 164 remain connected together and baked product 116 substantially retains its original shape, but segments 164 are easily separable because only a small piece 166 of baked material exists below each cut 168 in baked product 116.

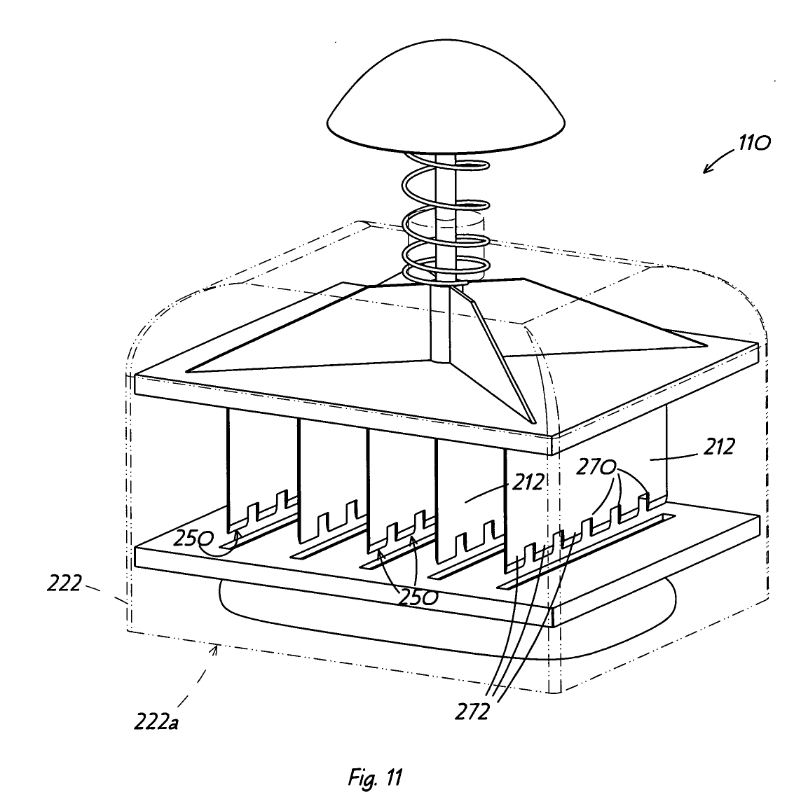

A third embodiment of sectioning device is shown in FIG. 11 and generally indicated at 210. Sectioning device 210 is substantially identical to sectioning device 110, except that blades 212 are notched at their lowermost ends. Consequently, when blades 212 cut into baked product 216, the notched sections 270 cut into baked product 216 to shallower depths than do the extended sections 272. Cutting edges 250 of blades 212 may travel all the way to the lower edge 222a of housing 222. Sections 272 would then cut completely through baked product 216, but notched sections 270 would not. Blades 212 may thereby form alternating thicker and thinner portions of material within the cuts made by blades 212 in baked product 216, thereby allowing for segments of baked product to be more easily detached from the whole.

It will be understood that while the present device has been disclosed as having a housing 22 with a wall which defines an interior cavity in which the plunger 14 reciprocates, the device may, alternatively comprises a frame-type housing that supports the plunger and allows the cutter blades to move up and down within the frame.

While the above disclosure relates to a hand-held device, it will be understood that for commercial purposes, the device can be powered.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A sectioning device for a baked product comprising:
a housing;
a plate movably mounted on the housing; said plate having an upper surface and a lower surface;
one or more blades extending outwardly from the lower surface of the plate and adapted to cut into the baked product; and wherein the plate is movable on said housing between an uppermost position where the blade does not contact the baked product and a lowermost position where the blade has cut into the baked product;
a cutting edge formed on the blade; and
a limiting mechanism for limiting the travel of the plate and blade; whereby at least a portion of the blade is prevented from cutting completely through the baked product.

2. The sectioning device as defined in claim 1, wherein the housing has a lower edge and the limiting mechanism stops the travel of the blade so that the cutting edge of the blade is positioned above the lower edge of the housing when the plate is in the lowermost position.

3. The sectioning device as defined in claim 2, further comprising a second plate disposed within the housing; said second plate being positioned between the plate and the lower edge of the housing.

4. The sectioning device as defined in claim 3, wherein the second plate includes a slot through which the blade travels when the plate moves between its uppermost and lowermost positions within the housing.

5. The sectioning device as defined in claim 4, wherein the blade is comprised of a plurality of partitioning blades and the second plate includes a plurality of slots complementary to the partitioning blades.

6. The sectioning device as defined in claim 5, wherein the partitioning blades radiate outwardly from a central axis.

7. The sectioning device as defined in claim 4, wherein a plurality of parallel blades extend outwardly from the plate, and the plurality of blades are spaced apart from each other.

8. The sectioning device as defined in claim 4, wherein the cutting edge of the blade is notched.

9. The sectioning device as defined in claim 8, wherein the cutting edge of the blade travels downwardly to at least the lower edge of the housing.

10. The sectioning device as defined in claim 4, further comprising a spring-biased plunger connected to the plate, the plunger being movable between a first position where the plate lies in the uppermost position and a second position where the plate lies in the lowermost position.

11. The sectioning device as defined in claim 10, further comprising a boss extending outwardly from an outer wall of the housing and being engageable with the plunger to limit the travel of the blade within the housing.

12. The sectioning device as defined in claim 1, wherein the housing includes an interior wall and the plate travels on the housing inwardly of said interior wall.

13. The sectioning device as defined in claim 12, wherein the interior wall defines an interior cavity and wherein the plate moves between the uppermost and lowermost positions within the interior cavity of the housing

14. The sectioning device as defined in claim 13, wherein the interior wall of the housing surrounds the blades and the interior wall has one of a cylindrical and rectangular shape.

15. The sectioning device as defined in claim 2, wherein the limiting mechanism stops the travel of the blade when the blade has cut through between 10% and 95% of the depth of the baked product.

16. The sectioning device as defined in claim 1, further comprising a power source for moving said plate into and out of contact with the baked product.

17. A method of sectioning a baked product comprising the steps of:
providing a sectioning device having a housing with a wall and a plunger-activated blade which travels in the housing interiorly of said wall between an uppermost and a lowermost position; the travel of the blade being limited by a limiting mechanism so that a cutting edge of the blade does not extend to a lower edge of the housing when the blade is in the lowermost position;
placing a baked product on a flat surface;
positioning the housing over the baked product; whereby the baked product lies within a perimeter created by the lower edge of the housing;
applying downward pressure to the plunger to cause the blade to move to its lowermost position and to cut into the baked product and form a plurality of segments that are joined together by strips of thinned baked material;
releasing the plunger to allow the blade to revert to its uppermost position within the housing;
removing the housing from over the baked product.

18. The method of sectioning a baked product as defined in claim 17, wherein the blade is notched and the step of applying downward pressure to the plunger causes the blade to travel within the housing to a lowermost position where the cutting edge of the blade extends to the lower edge of the housing.

19. The method of sectioning a baked product as defined in claim 18, further comprising the step of:
tearing a segment of baked material from the baked product.

20. The method of sectioning a baked product as defined in claim 17, wherein the sectioning device is connected to a power source and the step of applying downward pressure to the blade is achieved by using the power source to move the blade.
